(19) United States
(12) Patent Application Publication
(10) Pub. No.: US 2017/0101977 A1
(43) Pub. Date: Apr. 13, 2017

(54) Wave energy absorption device, a power take-off assembly and a wave energy system

(71) Applicant: Ocean Harvesting Technologies AB, Karlskrona (SE)

(72) Inventor: Mikael Sidenmark, LISTERBY (SE)

(21) Appl. No.: 15/389,460

(22) Filed: Dec. 23, 2016

Related U.S. Application Data
(63) Continuation of application No. PCT/SE2015/050737, filed on Jun. 24, 2015.

(30) Foreign Application Priority Data
Jun. 24, 2014 (SE) 1450782-6
May 22, 2015 (SE) 1550661-1

(51) Int. Cl. F03B 13/14; F15B 21/14; F15B 15/08

(52) U.S. Cl. CPC F03B 13/14; F15B 15/08; F15B 21/14; F05B 2220/706; F05B 2260/406; F05B 2260/4031; F05B 2240/93

(57) ABSTRACT

A wave energy absorption device comprises a buoy adapted to move with movements of water, and a buoy oscillation device attached to the buoy, the buoy oscillation device comprising an elongated means and a rotary means adapted to interact with the elongated means. A hydraulic pump with variable displacement is connected to the rotary means and connectable to a hydraulic circuit. When the buoy moves with movements of water, relative movement is created between the elongated means and the rotary means, whereby the hydraulic pump transforms kinetic energy into hydraulic energy which to the hydraulic hose, and whereby a torque is applied to the rotary means by the hydraulic pump to dampen or amplify the movements of the buoy. The buoy oscillation device provides individual control of the force applied to the buoy by change of displacement in the hydraulic pump.

### TECHNICAL FIELD

The present invention relates generally to a wave energy absorption device, a power take-off and generator assembly comprising energy storage, a hydraulic collection system connecting a plurality of wave energy absorption units to a common power take-off and generator assembly, wherein the force applied to each wave energy absorption device can be independently controlled without significant interference from the energy storage.

### BACKGROUND ART

Strategies for controlling the damping force applied to the buoy are widely studied with the purpose to increase the power capture for a wave energy converter. The optimal damping force to use depend greatly on the wave size. If the optimal damping force is not applied, the buoy will either be over or under dampened through the wave and will thus capture less power.

The most commonly used control strategy is the so called passive loading, and this is often compared with reactive control considered to be the optimal control strategy. Passive loading applies a damping force that is proportional to the velocity of the buoy and reactive control applies an optimal damping as well as controlling the phase of the buoy to resonate against the waves. Due to its proportional characteristics of the damping force to the velocity, passive loading gives very high peak forces in relation to the average power extracted from the wave, and the damping force profile is not optimal to capture the most power out of each wave. Reactive control provides much better power capture but the force required to control the phase is higher than needed for the damping and must be applied to push the buoy in some instances of the wave motion, and thus requires power to be reversed in the system. This is a challenge for the component sizing and efficiency of the power take-off system. Constant damping is another control strategy that is capable of capturing more power with less force than passive loading, and is more efficient than reactive control but does not control the phase and is therefore captures less power than reactive control.

Energy storage in the power take-off reduces the sizing requirements and increases the efficiency of components in the power take-off, and is necessary for a cost effective system as well as providing sufficient quality of the power output. But it is often difficult to control the damping force when adding energy storage to the power take-off before the generator. A hydraulic power take-off comprising a cylinder, an accumulator and a motor will apply a damping force that is proportional to the level of stored energy in the accumulator.

With the gravity storage connected with a hydraulic power take-off according to patent publication No. WO2014/0055033, the hydraulic pressure does not depend on the level of stored energy in the accumulator, instead the hydraulic pressure is proportional to the mass of the weight in the accumulator, its acceleration and the gear ratio from the weight to the buoy. With a fixed gear ratio, the damping force is close to constant which means that the power capture performance will not be optimal. The patent publication No. WO2014/0055033 shows that it is possible to tune the damping force with a variable gear ratio between the weight and the buoy, e.g. a variable displacement hydraulic motor, with the shaft connected to the carrier in the planetary gearbox. This allows rapid control of the system pressure and thereby of the damping force applied to the buoy by a hydraulic cylinder with fixed displacement, which is commonly used in hydraulic power take-offs in wave energy devices. This however has the limitation that the damping force can only be collectively controlled if multiple buoys are attached through a hydraulic collection system to a common hydraulic motor in a hub system with centralized smoothing and conversion to electricity.

### SUMMARY OF INVENTION

An object of the present invention is to provide a device that enables independent control of the force applied to multiple buoys attached to a common hydraulic collection system and central power take-off and generator assembly, which is more or less independent from the control of the generator and system pressure, and thereby the use of energy storage in the power take-off. It is also an objective of the present invention to provide a more efficient multi displacement pump arrangement, which enables reactive control to be implemented in a way that uses energy stored in the power take-off, to optimize power capture without adding significant losses to the system. An additional objective is to provide a power take-off and generator assembly that can be scaled up to comprise larger storage capacity and a higher power rating, to enable a larger number of buoys to be connected to it.

According to a first aspect of the invention, there is provided a wave energy absorption device, comprising: a buoy adapted to move with movements of water, and a buoy oscillation device attached to the buoy, the buoy oscillation device comprising an elongated means and a rotary means adapted to interact with the elongated means, which is characterized by a hydraulic pump with variable displacement connected to the rotary means (21b) and connectable to a hydraulic circuit, wherein, when the buoy moves with movements of water, relative movement is created between the elongated means and the hydraulic pump, whereby the hydraulic pump transforms kinetic energy into hydraulic energy.

In a preferred embodiment, the buoy oscillation device is a rack and pinion drive. The oscillation device can also be a winch system where the elongated means is a belt, wire or chain and the rotary means is a winch drum or chain sprocket.

In a preferred embodiment, the elongated means is attached to any of the following: a sea bed, a moving body with a relatively large mass to the buoy, and a piston or heave plate in the water, with a large added mass of water in relation to the mass of the buoy.

In a preferred embodiment, the hydraulic pump is a bi-directional pump in combination with a hydraulic Graetz bridge.

In a preferred embodiment, the hydraulic pump is a multi-displacement hydraulic pump, preferably a radial piston pump, more preferably a radial piston pump with two units of different sizes in a tandem arrangement.

In a preferred embodiment, the hydraulic pump has an infinitely variable displacement, preferably an axial piston pump with a swash plate.

In a preferred embodiment, multiple fixed displacement pumps, preferably 4-8 pumps, each with one rotary means attached to the same elongated means (21a), are provided.

In a preferred embodiment, the buoy oscillation device comprises a gear rack in a back to back arrangement with multiple rotary means attached to the elongated means from two sides to balance the horizontal forces between the elongated means and the rotary means.

In a preferred embodiment, each rotary means is connected to a hydraulic pump with a fixed relationship between rotary motion and torque, and flow and pressure, and wherein all first ports from the hydraulic pumps are connected to a first common hose, and all second ports are connected to a second common hose.

In a preferred embodiment, the wave energy absorption device comprises hydraulic control valves adapted to connect and disconnect each hydraulic pump individually to and from the hydraulic circuit.

In a preferred embodiment, the control valve is adapted to shift ports of the hydraulic pump connecting to high and low pressure hoses of the hydraulic circuit.

In a preferred embodiment, the control valve is adapted to stop flow from circulating in the hydraulic pump.

In a preferred embodiment, wave energy absorption device comprises a high pressure hydraulic accumulator and a low pressure accumulator connectable to the hydraulic circuit.

In a preferred embodiment, the hydraulic accumulators has a pre-charge pressure to provide the system with a high and narrow pressure range.

According to a second aspect of the invention a power take-off assembly is provided, comprising: a power take-off oscillation device connected to an accumulator, the power take-off oscillation device comprising an elongated means and a rotary means adapted to interact with the elongated means, and an energy storage connected to the elongated means, which is characterized by a plurality of generator modules connected to the rotary means, wherein the power take-off oscillation device comprises a plurality of rotary means connected with the same elongated means, whereby the plurality of generator modules are in connection with the same energy storage through the power take-off oscillation device.

In a preferred embodiment, each generator module comprises a hydraulic motor attached with a carrier of a planetary gearbox with a floating ring gear attached with the power take-off oscillation device for storing and retrieving energy to the energy storage device, and with a sun gear adapted to drive a generator.

In a preferred embodiment, each generator module comprises a hydraulic pump/motor attached with the power take-off oscillation device for storing and retrieving energy to the energy storage, and a second hydraulic motor is adapted to drive a generator.

In a preferred embodiment, the power take-off oscillation device is a rack and pinion drive.

In a preferred embodiment, the energy storage is a weight in which potential energy can be stored and retrieved.

In a preferred embodiment, the energy storage is an elastic energy storage to which elastic energy can be stored and retrieved.

In a preferred embodiment, power take-off assembly comprises a mechanical gearbox with multiple gear steps provided between the planetary gearbox and hydraulic motor.

In a preferred embodiment, the elongated means is any of the following: a chain, a roller screw, a belt, and a wire, and the rotary means is adapted to the transform linear motion in the elongated means into a rotary motion.

In a preferred embodiment, the hydraulic motor is a fixed displacement hydraulic motor.

In a preferred embodiment, the power take-off assembly comprises a flywheel connected to a shaft of the generator.

In a preferred embodiment, the power take-off assembly comprises a hydraulic accumulator connectable to the hydraulic circuit,

According to a third aspect of the present invention, a wave energy system is provided comprising a power take-off assembly according to the invention and a plurality of wave energy absorption devices according to the invention, preferably at least three wave energy absorption devices, more preferably at least 25 wave energy absorption devices, connected to the power take-off and generator assembly by means of a hydraulic circuit.

In a preferred embodiment, each buoy is connected to a piping system on the seabed that collects the hydraulic flow from all wave energy absorption devices to the hub. Alternatively the hydraulic fluid can be collected through hydraulic hoses, going from wave energy absorption device to wave energy absorption device until reaching the hub.

In a preferred embodiment, the wave energy system comprises a pressure relive valve adapted to open on a maximum pressure set for the hydraulic circuit and let hydraulic fluid pass directly from a high pressure hose to a low pressure circuit.

In a preferred embodiment, the force applied to the elongated means in each buoy connected to the power take-off and generator assembly, can be controlled independently without significant interference with energy storage or combinations thereof.

### BRIEF DESCRIPTION OF DRAWINGS

The invention is now described, by way of example, with reference to the accompanying drawings, in which:

FIG. 1a is a schematic view of a wave energy system with two buoys, with flexible hoses connecting the buoys to the hub.

FIG. 1b is a schematic view of a wave energy system with two buoys, with fixed piping on the sea bed that connects the buoys to the hub.

FIG. 2 is a schematic view of a power take-off for one buoy attached with a hub.

FIG. 3 shows the same power take-off system as FIG. 2 but with three buoys attached to the same hub.

FIG. 4 shows a similar power take-off system as FIG. 3 with hydraulic accumulators in the buoys.

FIG. 5 shows a similar power take-off system as FIG. 3 but with one hydraulic accumulator in the hub instead of in the buoys.

FIG. 6 shows a combination of FIGS. 4 and 5, with hydraulic accumulators added in the buoys as well as in the hub.

FIG. 7 shows an alternative configuration without the gravity storage device in the hub, and with all energy smoothing instead done with hydraulic accumulators in the buoys.

FIG. 8 shows a similar configuration as FIG. 7 with all smoothing done with hydraulic accumulators in the hub.

FIG. 9 shows an alternative with hydraulic accumulators both in the buoys and in the hub.

FIG. 10a shows a configuration according to the invention with multiple fixed displacement pumps with one pinion each attached to the same rack in the buoys, and multiple fixed displacement motors in the hub, each attached to the same gear rack through the ring gear of a planetary gearbox and a pinion.

FIG. 10b shows a configuration expanded with a cascade gearbox in the buoy compared to FIG. 10a.

FIG. 10c shows a configuration expanded with cascade gearboxes also in the hub compared to FIG. 10b.

FIG. 11 shows a similar configuration of the power take-off as FIG. 10a but with a pump/motor arrangement without the planetary gearbox connected to the gear rack in the gravity storage, and with one separate hydraulic motor for every generator.

FIG. 12 shows a similar configuration as FIG. 10a in a top view.

FIGS. 13a and 13b show a similar configuration as in FIG. 12 with hydraulic accumulator for energy storage and generator for electricity generation on board the buoy.

FIGS. 14-17 show perspective views of various embodiments of the invention.

### DESCRIPTION OF EMBODIMENTS

In the following, a detailed description of a wave energy system according to the invention, including an oscillation device for improved power capture and efficiency in combination with energy storage in the power take-off, and a plurality of wave energy absorption devices connected to a common hub according to the invention, will be described in detail.

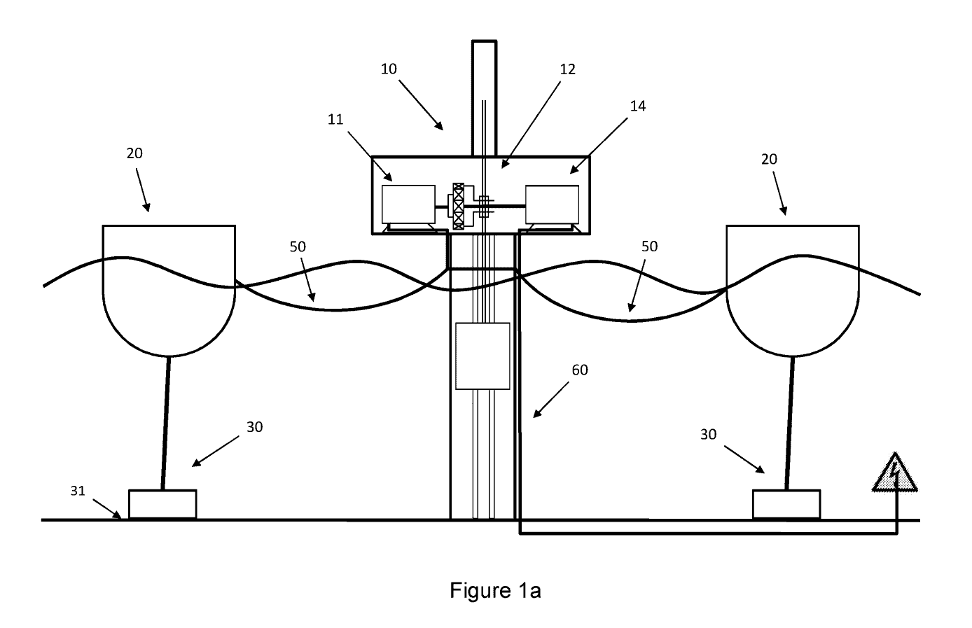

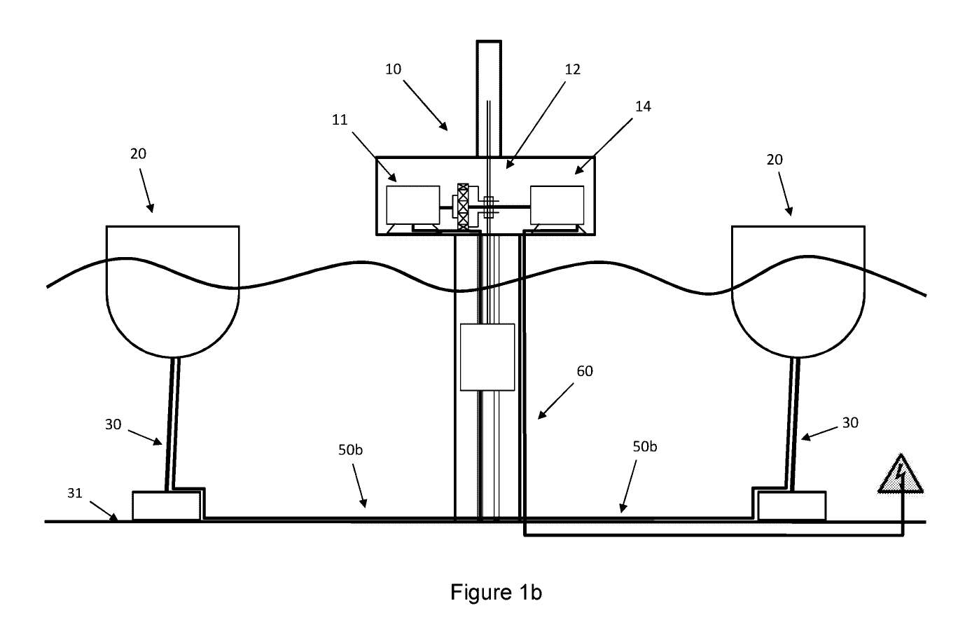

FIG. 1a is a schematic view of a wave energy system with two buoys 20 attached via flexible hydraulic hoses 50 to a power take-off and generator assembly in the form of a hub 10. Each buoy is moored to the seabed with a mooring rope 30 to the sea bed 31. The hub comprises a hydraulic motor 11, an energy storage device in the form of a gravity storage device 12 and a hydraulic generator 14, which exports electric power through cable 60.

FIG. 1b is a similar schematic view as FIG. 1a but with buoys connecting to a fixed piping system 50b on the sea floor 31 to transfer high pressure hydraulic fluid to the hub 10. A fixed piping system on the sea bed can be provided with larger diameter and lower cost compared with flexible hoses and can be used to reduce the total cost and losses for the hydraulic collection system.

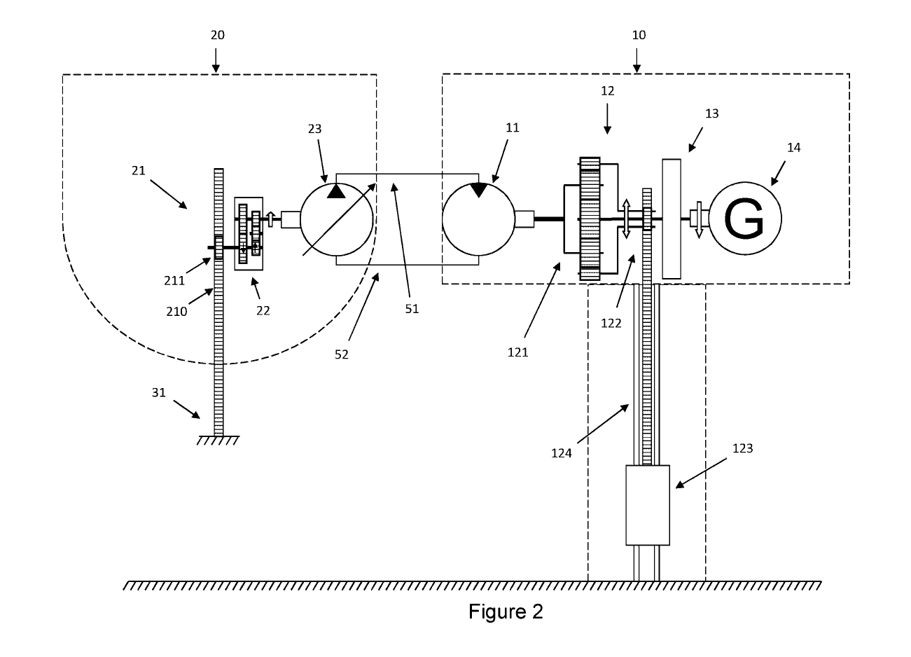

FIG. 2 is a schematic view of the power take-off for one buoy 20 attached to a hub 10, wherein the power take-off in the buoy comprises an oscillation device in the form of a gear rack and pinion drive 21. The rack and pinion drive comprises an elongated means in the form of a gear rack 21a and a rotary means in the form of a pinion 21b. The gear rack 21a is attached to a body in the form of a sea bed 31. Alternatively, this body could be a moving body with a relatively large mass compared to the buoy 20. This body could also be a piston or so called heave plate in the water, with a large added mass of water in relation to the mass of the buoy.

The power take-off also comprises a mechanical rectifier 22, which converts bi-directional rotation of the pinion into unidirectional rotation of the shaft of the variable displacement hydraulic pump 23. Alternatively a bi-directional pump can be used in combination with hydraulic graetz bridge or similar to provide a unidirectional high pressure export flow to the high pressure hose 51 and a unidirectional low pressure return flow from the low pressure hose 52. As a special case of a variable displacement pump, a pump with multi displacement, i.e. with discrete steps of displacements, can be used. Thus, the term “variable displacement” encompasses all ways of changing the displacement of a hydraulic pump or motor.

This shown arrangement allows detailed control of the damping force to be applied to the buoy by adjustment of the displacement in the variable displacement pump, while the pressure in the high and low pressure hoses 51 and 51 can remain more or less constant. As an alternative, the buoys can pump sea water through a single hose to the hub. The rack and pinion drive connected with a variable rotating hydraulic pump thereby solves a major issue with applying detailed control to the buoys with hydraulic power take-offs incorporating hydraulic accumulators and fixed displacement hydraulic cylinder.

The buoy is connected to a separate unit, a hub 10, through high and low pressure hydraulic hoses 51 and 52 which are connected to a hydraulic motor 11 in the hub. The motor converts hydraulic power into mechanical power. The mechanical power is smoothed by an energy storage device, in the shown embodiment a gravity storage device 12, comprising a planetary gearbox 121 with a floating ring gear attached with a rack and pinion drive 122 and an accumulator weight 123. Other types of elongated means to lift the weight in the gravity storage device can also be used, such as a chain, roller screw, belt or wire.

The weight runs on a linear guide 124 to make sure the rack is always aligned with the gearbox. The accumulator weight in the gravity storage provides the generator and hydraulic motor with a close to constant torque independently of the level of stored energy in the accumulator, i.e. the position of the weight, and thereby also a constant range of the damping forces available to the buoys attached with the hub through the hydraulic collection system and the range of displacements in the hydraulic pump in the buoys. The torque varies slightly due to the acceleration of the weight and friction in the transmission. A given torque to the hydraulic accumulator can be provided either with a large weight that moves slowly due to a high gear ratio, or a smaller weight that moves more quickly due to a lower gear ratio between the weight and the motor. This way the accumulator system can be designed according to specified requirements on how much the torque and pressure can be allowed to fluctuate.

Peak pressure and torque can also be limited by a pressure relive valve, not shown, that opens on the maximum pressure set for the system and lets hydraulic fluid pass directly from the high to low pressure circuit. With fixed displacement in the hydraulic motor 11, the force applied to the buoy through the power take-off remains close to constant. It is possible to extend the range of damping force that can be applied in the buoys by changing the displacement in the hydraulic motor 11 and thus the system pressure. Alternatively, a mechanical gearbox with multiple gear steps can be integrated in the power take-off between the planetary gearbox and hydraulic motor in the hub.

The gravity storage device also provides a constant speed output to the generator, which is achieved by the torque balance between the weight in the gravity storage and the speed dependent torque by the generator. The speed is controlled by adjusting the damping in the generator and thus change the speed at which the breaking torque of the generator will be equal to the driving torque from the weight. The output shaft, sun gear, is connected to generator 14, and a flywheel 13 can optionally be used to smooth the torque variations coming from accelerations in the weight. The generator can in this way be provided with a constant speed, torque and thereby also power input despite variations of speed before the gravity storage device and torque before the flywheel. This ensures that the generator can operate with a constant power output and maximum efficiency and also reduces the sizing of the generator.

Pumps and motor can be implemented with infinite variable displacement between zero and full displacement, typically found in axial piston motors with a swash plate to adjust the stroke length of the pistons. This type of pump/motor offers very detailed and rapid control of the damping force, but can be inefficient when operating at part displacement.

An alternative option for the pumps and motor is to use multi displacements, typically found in radial piston pumps/motors. Multiple unites can be combined to offer the number of steps required to come close to the power capture performance with infinitely variable displacement. Multiple units can either be attached to the same shaft in a tandem arrangement, or on separate shafts to with one pinion each attached with the same gear rack. Control valves are used for engage/disengage units in both arrangements. Some types also has the capability to disengage/engage individual cylinders within each unit. Multi displacement pumps and combo pumps has the advantage of maintaining high efficiency also at part displacement. This type of pump also has in the order of a magnitude higher torque to weight ratio, power density, compared with variable displacement pumps.

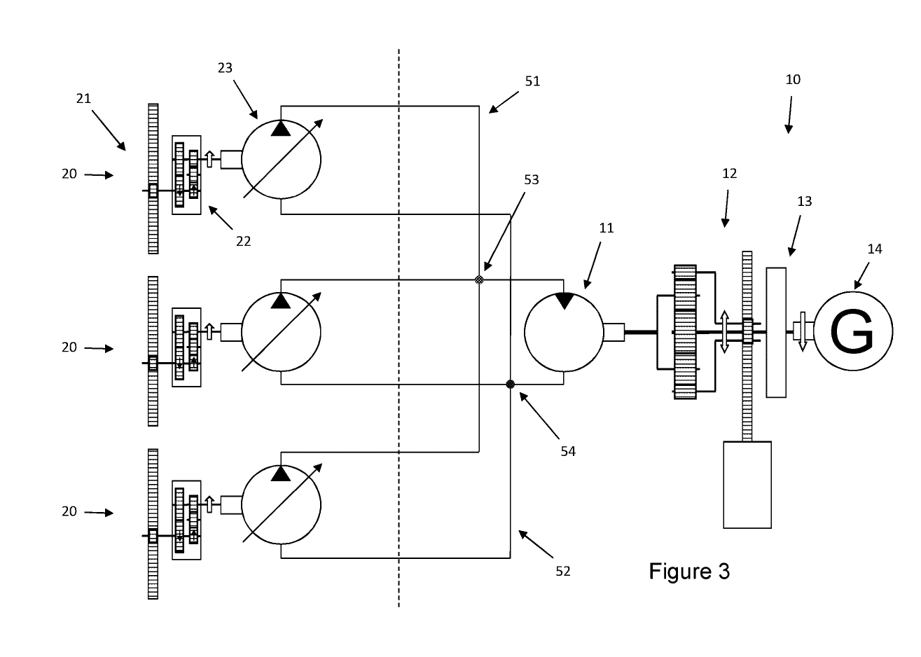

FIG. 3 shows the same power take-off system as FIG. 2 but with three buoys attached to a single hub, with the hydraulic hoses joining together at points 53 and 54 before the hydraulic motor 11. This represents a wave energy converter system with multiple buoys to a single hub; the same schematics can be used for any number of buoys. In this configuration there are no hydraulic accumulators in the hydraulic circuit which is here shown as a closed system, it can also be an open system with a reservoir before the pump in each buoy. A pump can be used between the high and low pressure sides of the hydraulic circuit to control the pressure on the low pressure side, not shown. This would prevent gradually increasing pressure on the low pressure side due to leakage from high to low pressure in the pumps, without the need to use an open system with reservoirs in the buoys. This way the return flow to each buoy will always be balanced with the export flow, which is not the case with reservoirs where the export flow from each buoy will be different while the return flow will be the same for all buoys. An open system with reservoirs needs additional volume and functionality to limit the fill level of each reservoir, in order to ensure that there is always fluid in every reservoir.

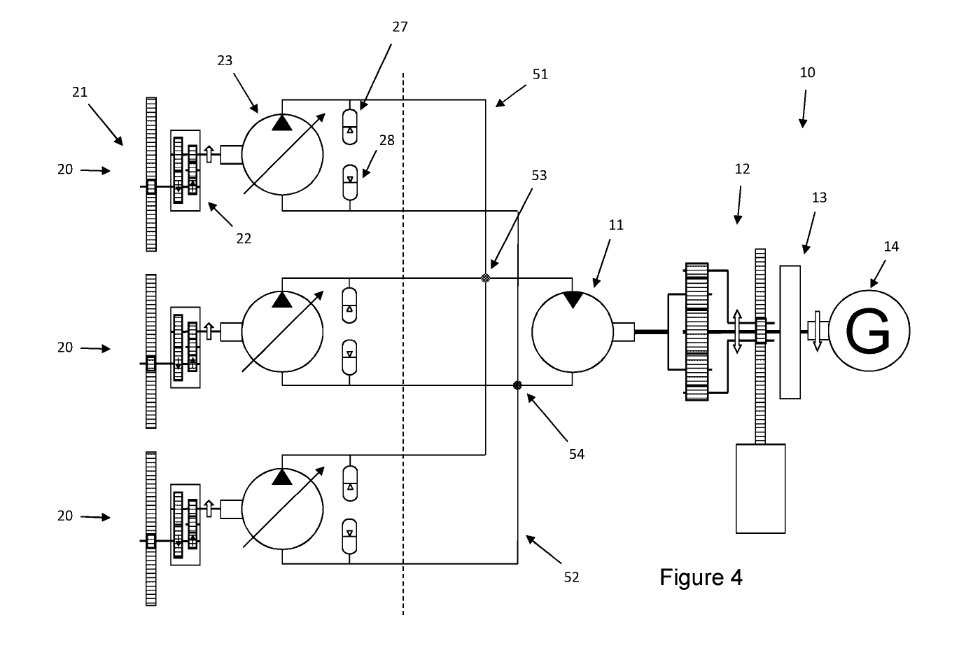

FIG. 4 shows a similar power take-off system as FIG. 3 with high pressure hydraulic accumulator 27, low pressure accumulators 28 and hydraulic pump 23. Small hydraulic accumulators in the buoys reduce the peak flow rates through the hoses to the hub, while the wave to wave smoothing is still done mainly by the gravity storage device 12 in the hub and maintains the pressure on a constant level. The hydraulic accumulators in combination with the gravity storage reduce the acceleration of the weight in the gravity storage device, and thereby the torque and pressure variations in the system. Instead of low pressure accumulators 28, open reservoirs can be used. In this case the maximum fill level in each reservoir is limited by a hydraulic orifice valve or similar, not shown, to make sure that the return fluid is distributed evenly to all buoys.

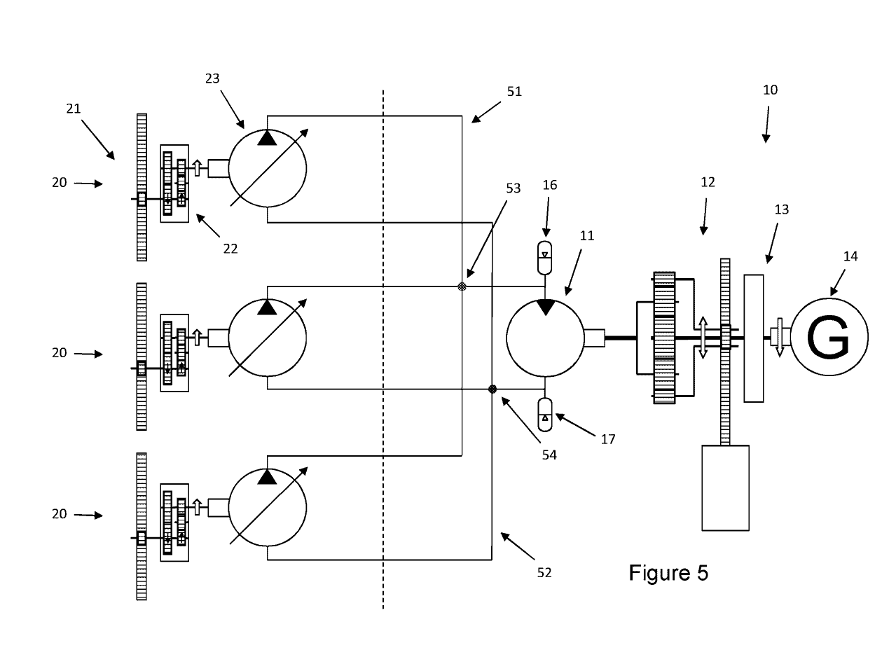

FIG. 5 shows a similar power take-off system as FIG. 3 but with high and low pressure hydraulic accumulators 16 and 17 in the hub instead of in the buoys. This may be a more cost efficient solution to reduce the maximum acceleration of the weight to smooth the pressure variations in the hydraulic collection system, but does not have the advantage of reducing the peak flow rate in the export hoses from the buoys.

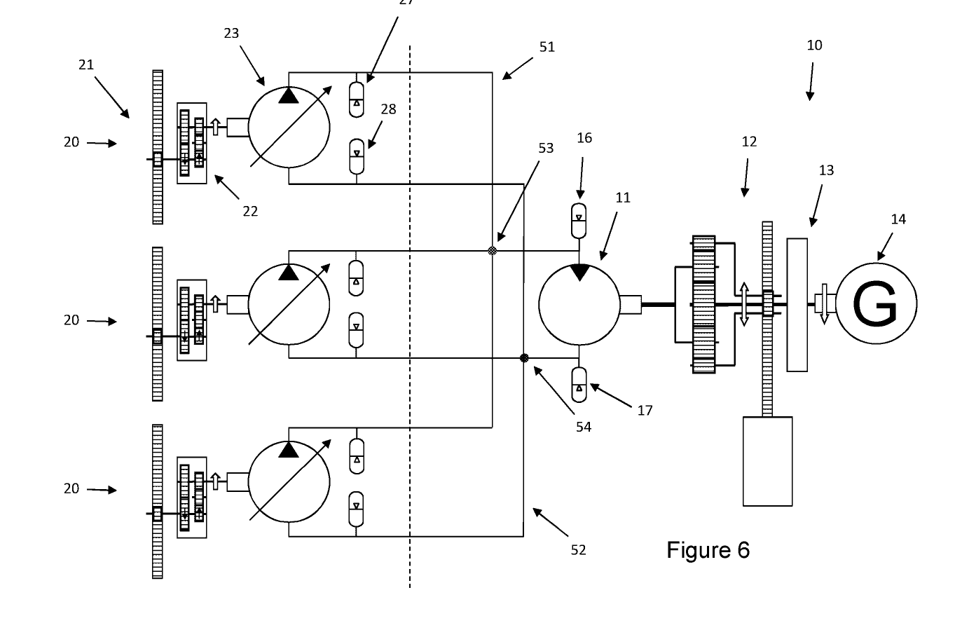

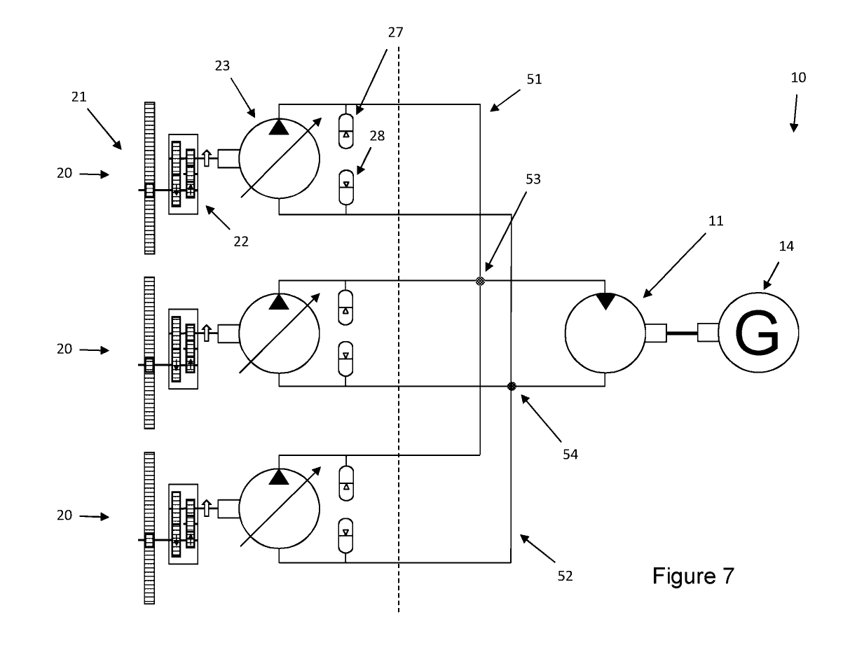

FIG. 6 shows a combination of FIGS. 4 and 5, with hydraulic accumulators added in the buoys as well as in the hub. It should be noted that configurations shown in FIGS. 4 to 6 alter the behavior of the hydraulic accumulators compared to using only hydraulic accumulators in the system as shown in FIGS. 7 to 9. The hydraulic accumulators will in combination with the gravity storage device function as bumpers that smoothers the pressure variations caused by acceleration forces in the weight.

FIG. 7 shows an alternative configuration without the gravity storage device in the hub, and with all energy smoothing instead done with hydraulic accumulators in the buoys. It should be noted that the rack and pinion drive 21 with variable displacement pump 23 still allows full control of the damping force applied to the buoys within the damping force range set by the current level of stored energy (pressure) in the hydraulic accumulators, which is very complicated to achieve with other proposed hydraulic power take-offs in prior arts where a hydraulic cylinder with fixed displacement is used in combination with hydraulic accumulators.

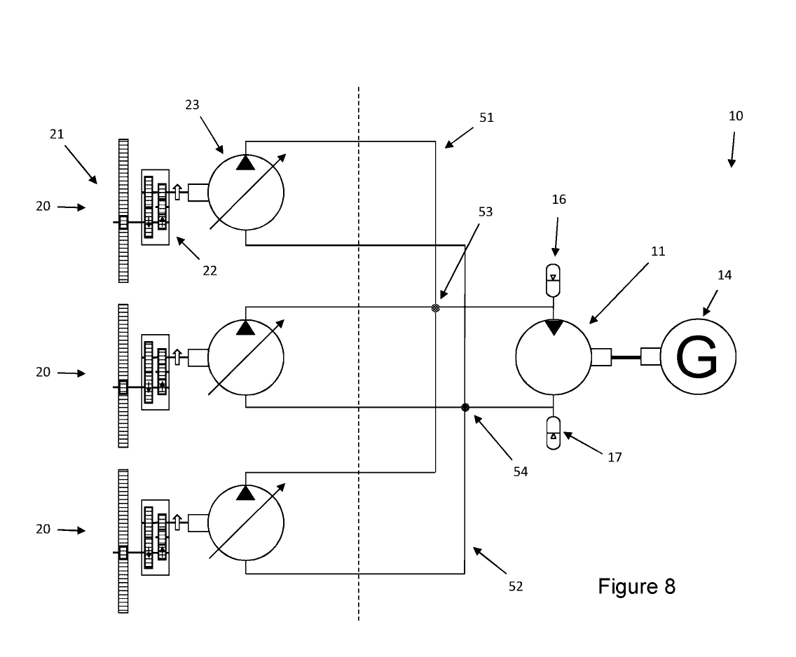

FIG. 8 shows a similar configuration as FIG. 7 but with hydraulic accumulators 16 and 17 in the hub instead of in the buoys.

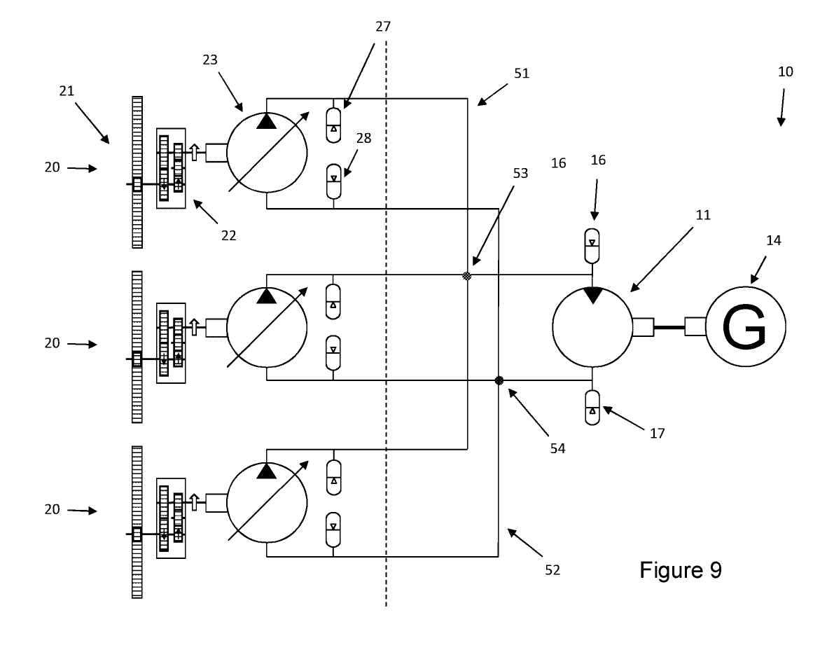

FIG. 9 shows an alternative with hydraulic accumulators both in the buoys, typically small accumulators 27, 28 to reduce the peak flow rate through the hoses to the hub, and large hydraulic accumulators 16 and 17 in the hub to store energy over consecutive waves.

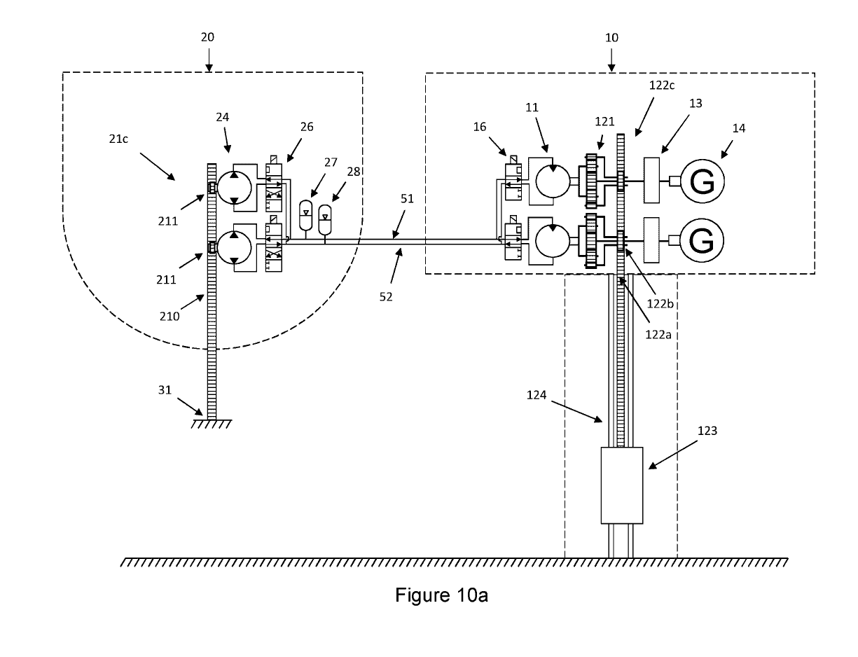

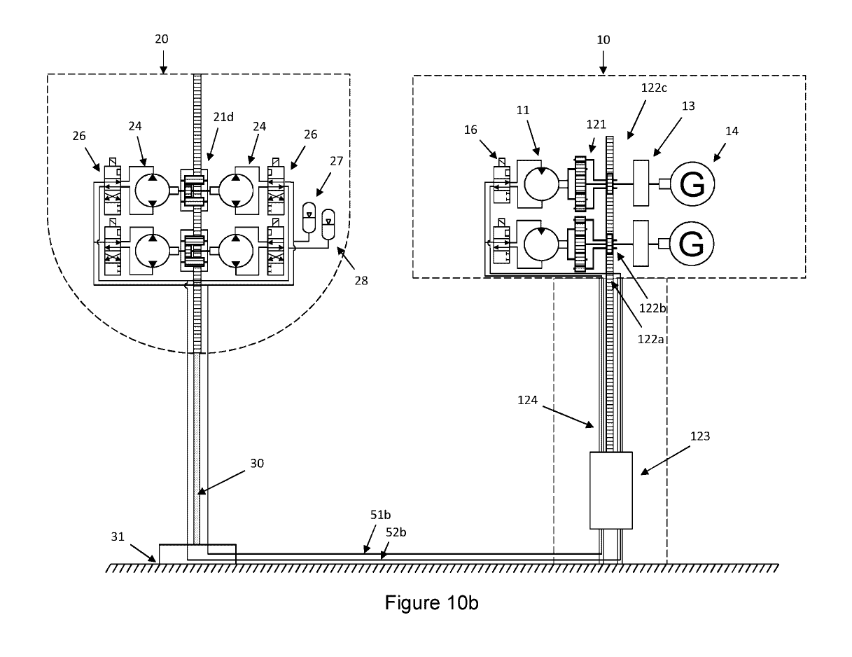

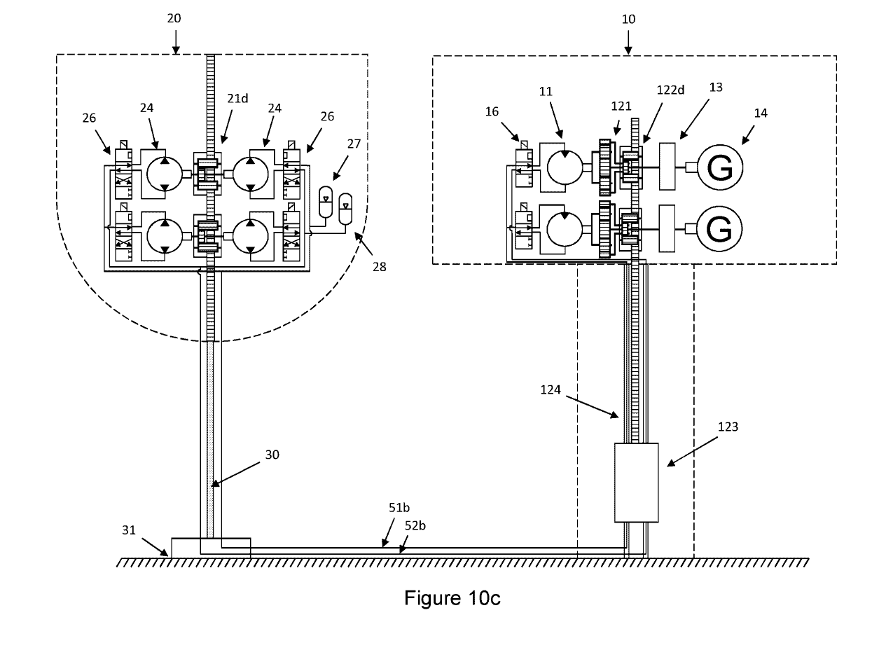

FIG. 10a shows a configuration with a variable displacement hydraulic pump in the form of multiple fixed displacement pumps 24 with one pinion each attached to the same rack 21c in the buoys. Thus, the term “variable displacement hydraulic pump” also encompasses a variable displacement hydraulic system comprising several fixed displacement hydraulic pumps which are selectively connectable to the same elongated means, in the shown embodiments gear rack. Here two pumps are shown but a larger number of pumps is preferred, typically 4-8 pumps, to share the load applied to the rack over the pinions and to enable detailed control of the force applied to the gear rack by using the hydraulic control valves 26 to connect/disconnect each pump individually from the circuit. The control valve further has the function to shift the ports of the pump connecting to the high and low pressure hoses 51 and 52. This can be used to actively control the direction of the force applied to the gear rack to either dampen the buoy to capture power or amplify it's motion to control the phase of the buoy, i.e. to apply reactive force control. In a preferred embodiment, the control valve 26 also has a position to stop the flow from circulating in the pump and thereby block the movement of the gear rack. When the last function is used, a cross over valve should be used between the pump and the control valve that enables fluid to cross over when a pressure limit is exceeded, not shown, to prevent damage to the system.

The hub 10 shows a similar arrangement 122c with multiple rotary means 122b, here embodied as pinions, connected to a single elongated means 122a, here embodied as a rack, where each pinion 122b is connected to the floating ring gear of the planetary gear box in a drive train module comprising a fixed displacement hydraulic motor 11 with control valve 16, planetary gearbox 121, optionally a flywheel 13, and a generator 14. The system pressure in the hydraulic collection system can be controlled by disengaging/engaging motors from the rack.

Hydraulic pumps and motors available for purchase are limited in size. The proposed arrangement overcomes this limitation by adding multiple drive trains to the same gear rack. This way the storage capacity in the gravity storage in the hub can be increased and a single hub can be used for collecting hydraulic power from all buoys in a complete array of buoys. The multiple drive train assembly can be scaled to carry any weight in the gravity storage device. When larger hydraulic motors becomes available, the number of drive trains can be reduced for a certain capacity to benefit further from the scale advantages.

FIG. 10b shows a similar configuration as FIG. 10, but with multiple pinions in a cascade arrangement according to patent publication WO2012008896A1 to distribute the load applied to the gear rack from each pump. Another difference is that the high and low pressure hoses run down to and along the sea bed 31, as shown by the designations 51b and 52b.

FIG. 10c shows a similar configuration of the power take-off as FIG. 10b but with the floating ring gear of the planetary gearbox 121 in the hub 10 attached with a cascade gear box 122d to increase the number of pinions in connection with the rack, and thereby reduce the force transferred to the rack from each pinion.

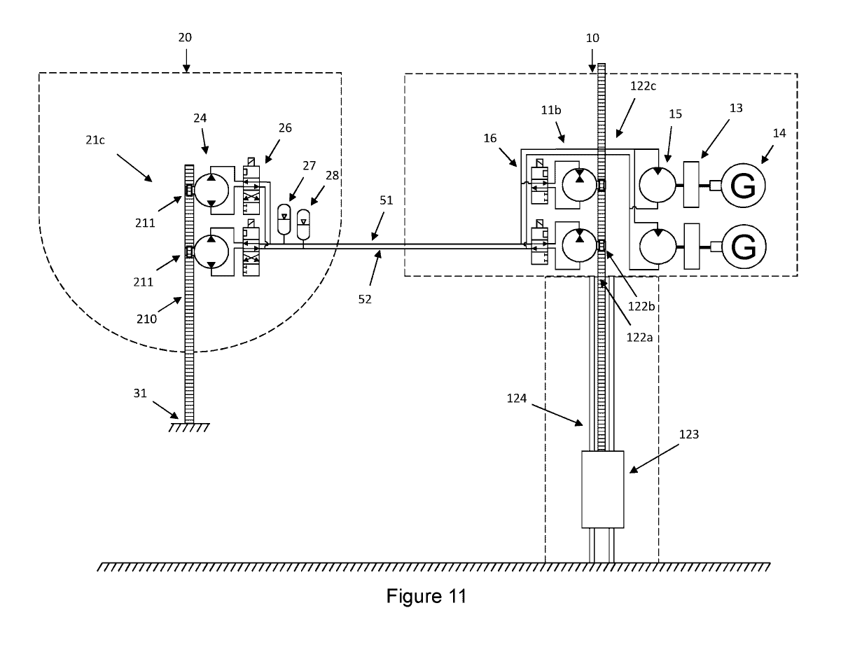

FIG. 11 shows a similar configuration of the power take-off as FIG. 10a, but without the planetary gearbox in the gravity storage device. Instead a pump/motor 11b is used for storing and retrieving energy to the accumulator weight 123, and a second hydraulic motor 15 drives the generator. This configuration resembles the hydraulic system shown in FIG. 8 with conventional gas pressure hydraulic accumulators, but provides a constant pressure independently of the level of stored energy in the accumulator, and stores energy without using gas compression which avoids thermodynamic losses from the irreversible gas compression cycle.

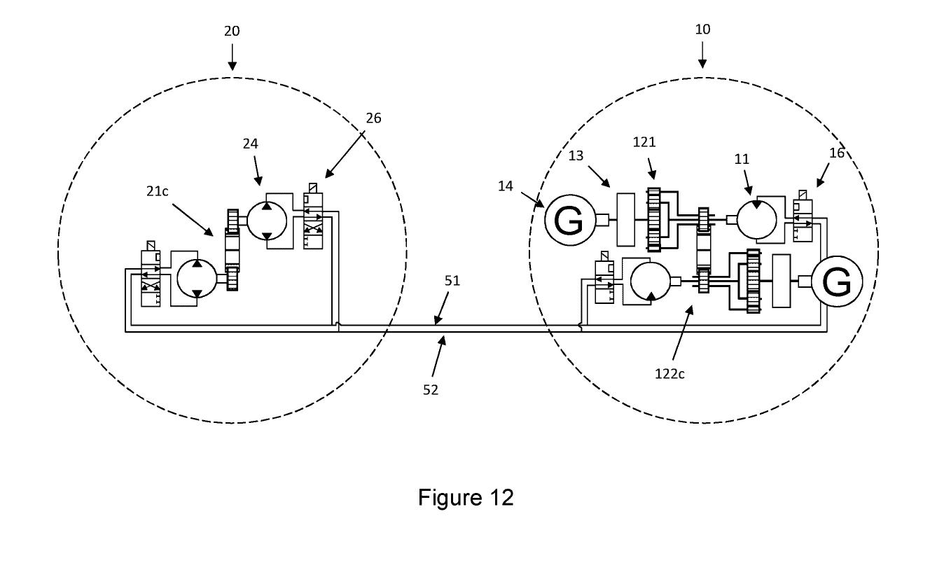

FIG. 12 shows a similar configuration as FIG. 10a in a schematic top view. The gear rack 21 a is here comprised of two units in a back to back arrangement to balance the horizontal loads on the rack. It is preferred to use the rack in this way and add the pumps pair wise to balance the loads in the system in an optimal way. Each pump 24 is here controlled with control valve 26, but the same control valve can also be used pair-wise for the pumps. A similar back to back rack and multi pinion drive unit 122c is used in the hub to lift the weight in the gravity storage device.

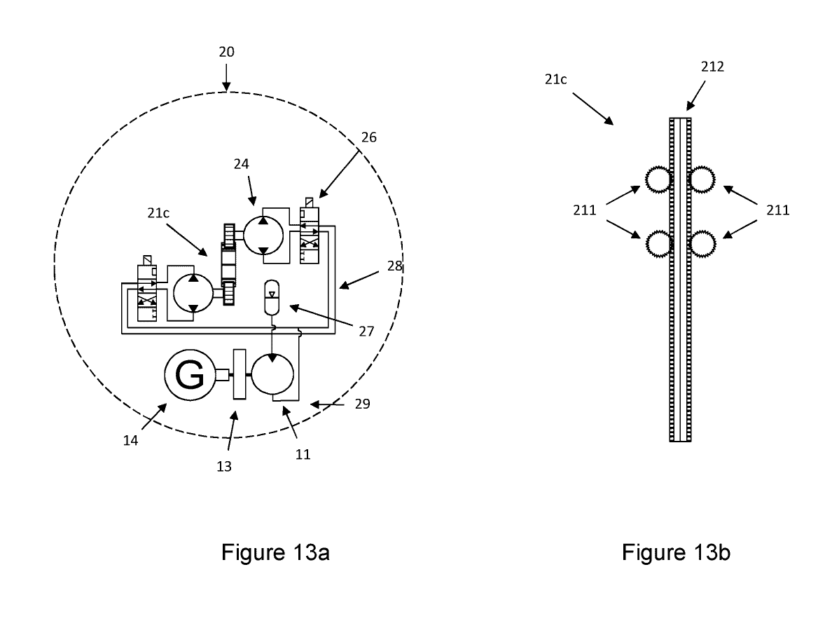

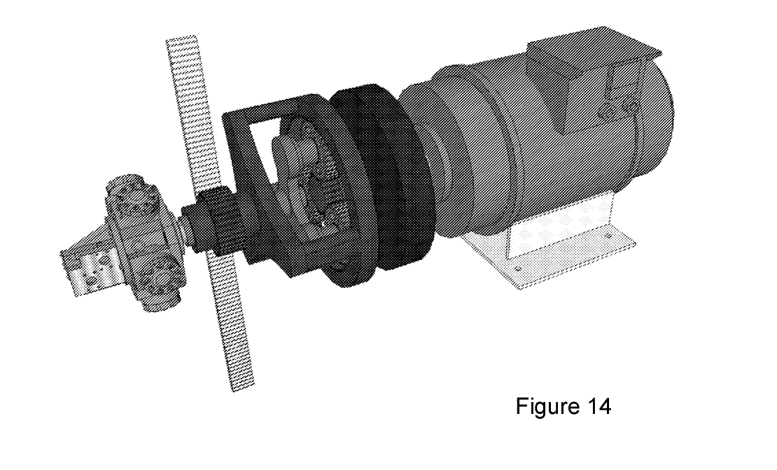

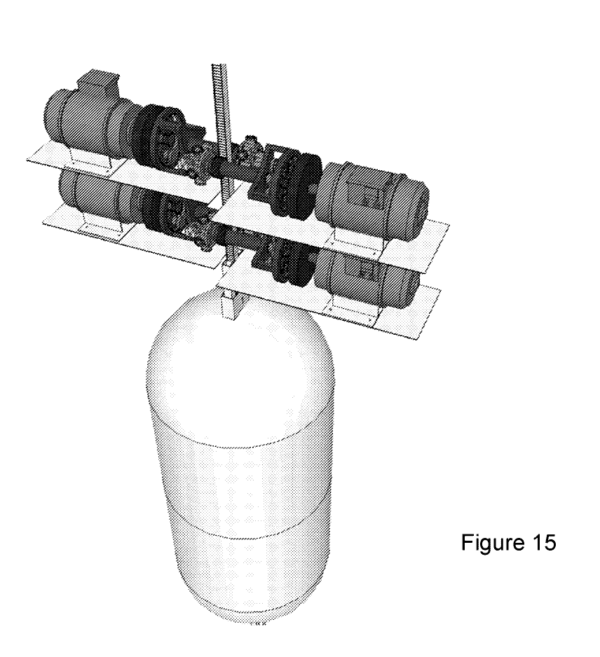

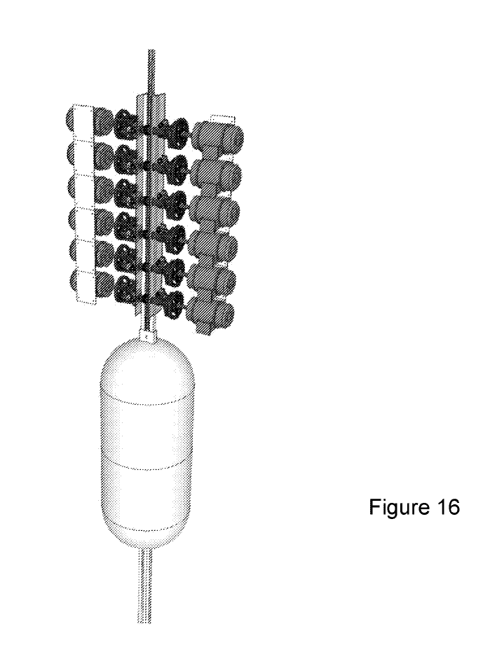

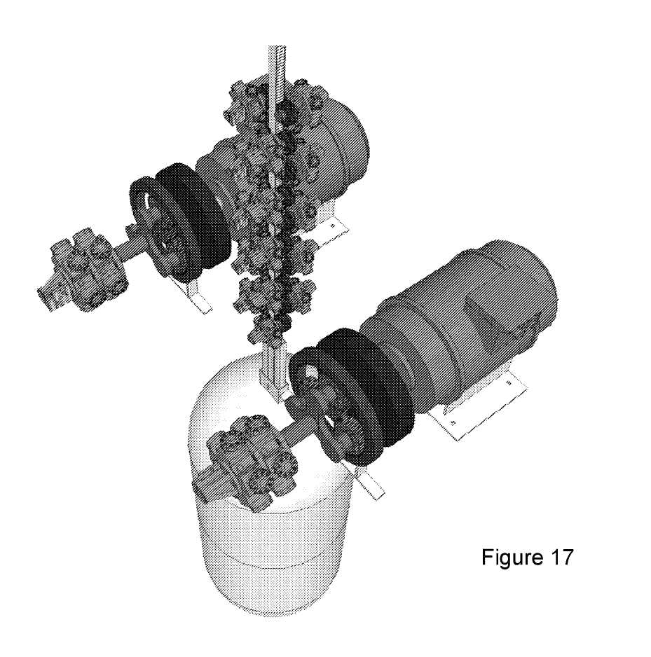

FIG. 13a shows the same back to back gear rack and multiple pinion drive 21 c with fixed displacement pumps 24 and control valves 26 as FIG. 12, but in this case power smoothing is done entirely with on board storage in the form of hydraulic accumulators and electrical energy is also generated in the buoy. This configuration combines the advantage of a compact hydraulic power take-off with hydraulic accumulation and detailed control of the damping force in an efficient way by use of multiple fixed displacement pumps attached to the same gear rack. FIG. 13b shows a side view of the back to back gear rack with multiple pinions, without the other components.

Preferred embodiments of a wave energy converter system has been described. It will be realized that this can be varied within the scope of protection defined by the claims without departing from the inventive idea. Thus, although racks and pinions have been described as the device to convert linear motion into a rotation, alternatives, such as chains, roller screws, belts, wires or similar can be used.

In one embodiment, the energy storage 123 in hub 10 is in the form of an elastic component such as rubber cord or similar that stores elastic energy instead of potential energy, instead of the weight shown in the embodiments in the figures.

Wave energy systems have been described with one or more hydraulic accumulators. It will be appreciated that these hydraulic accumulators may have a high pre-charge pressure to provide the system with a high and narrow pressure range in order to better utilize the hydraulic pumps and motors in the system.

Power take-off assemblies in the form of hubs 10 have been described. It will be realized that the different parts of these assemblies need not be co-located,

It will be realized that a wave energy converter system according to the invention in one form comprises a power take-off and generator assembly and a plurality of wave energy absorption devices at a distance from but connected to the power take-off and generator assembly, wherein each of the plurality of wave energy absorption devices comprises a device to convert linear motion into a rotation and a hydraulic pump, wherein the displacement of the hydraulic pumps is variable. The device to convert linear motion into a rotation is preferably a rack and pinion drive.

1. A wave energy absorption device, comprising:
a buoy adapted to move with movements of water, and
a buoy oscillation device attached to the buoy, the buoy oscillation device comprising an elongated means and a rotary means adapted to interact with the elongated means,
wherein a hydraulic pump with variable displacement is connected to the rotary means and connectable to a hydraulic circuit,
wherein, when the buoy moves with movements of water, relative movement is created between the elongated means and the hydraulic pump, whereby the hydraulic pump transforms kinetic energy into hydraulic energy.

2. The wave energy absorption device according to claim 1, wherein the buoy oscillation device is a rack and pinion drive.

3. The wave energy absorption device according to claim 1, wherein the elongated means is attached to any of the following: a sea bed, a moving body with a relatively large mass to the buoy, and a piston or heave plate in the water, with a large added mass of water in relation to the mass of the buoy.

4. The wave energy absorption device according to claim 1, wherein the hydraulic pump is a bi-directional pump in combination with a hydraulic Graetz bridge.

5. The wave energy absorption device according to claim 1, wherein the hydraulic pump is a multi-displacement hydraulic pump, preferably a radial piston pump, more preferably a radial piston pump with two units of different sizes in a tandem arrangement.

6. The wave energy absorption device according to claim 5, wherein the hydraulic pump has an infinitely variable displacement, preferably an axial piston pump with a swash plate.

7. The wave energy absorption device according to claim 1, comprising multiple fixed displacement pumps, preferably 4-8 pumps, each with one rotary means attached to the same elongated means.

8. The wave energy absorption device according to claim 7, wherein the buoy oscillation device comprises a gear rack in a back to back arrangement with multiple rotary means attached to the elongated means from two sides to balance the horizontal forces between the elongated means and the rotary means.

9. The wave energy absorption device according to claim 7, wherein each pump is connected to the gear rack through cascade gearboxes, each comprising multiple rotary means.

10. The wave energy absorption device according to claim 1, wherein each rotary means is connected to a hydraulic pump with a fixed relationship between rotary motion and torque, and flow and pressure, and wherein all first ports from the hydraulic pumps are connected to a first common hose, and all second ports are connected to a second common hose.

11. The wave energy absorption device according to claim 1, comprising hydraulic control valves adapted to connect and disconnect each hydraulic pump individually to and from the hydraulic circuit.

12. The wave energy absorption device according to claim 11, wherein the control valve is adapted to shift ports of the hydraulic pump connecting to high and low pressure hoses of the hydraulic circuit.

13. The wave energy absorption device according to claim 11, wherein the control valve is adapted to stop flow from circulating in the hydraulic pump.

14. The wave energy absorption device according to claim 1, comprising a hydraulic high pressure accumulator and a hydraulic low pressure accumulator connectable to the hydraulic circuit.

15. The wave energy absorption device according to claim 14, wherein the hydraulic accumulators has a pre-charge pressure to provide the system with a high and narrow pressure range.

16. A power take-off assembly, comprising:
a power take-off oscillation device connected to an accumulator, the power take-off oscillation device comprising an elongated means and a rotary means adapted to interact with the elongated means, and
an energy storage connected to the elongated means, wherein
a plurality of generator modules connected to the rotary means,
wherein the power take-off oscillation device comprises a plurality of rotary means connected with the same elongated means, whereby the plurality of generator modules is in connection with the same energy storage through the power take-off oscillation device.

17. The power take-off assembly according to claim 16, wherein each generator module comprises a hydraulic motor attached with a carrier of a planetary gearbox with a floating ring gear attached with the power take-off oscillation device for storing and retrieving energy to the energy storage device, and with a sun gear adapted to drive a generator.

18. The power take-off assembly according to claim 17, wherein the floating ring gear of the planetary gearboxes is attached to the power take-off oscillation device through a cascade gearbox comprising multiple rotary means in connection with the elongated means.

19. The power take-off assembly according to claim 18, comprising a mechanical gearbox with multiple gear steps provided between the planetary gearbox and hydraulic motor.

20. The power take-off assembly according to claim 17, wherein each generator module comprises a hydraulic pump/motor attached with the power take-off oscillation device for storing and retrieving energy to the energy storage, and a second hydraulic motor is adapted to drive a generator.

21. The power take-off assembly according to claim 17, wherein the power take-off oscillation device is a rack and pinion drive.

22. The power take-off assembly according to claim 17, wherein the energy storage is a weight in which potential energy can be stored and retrieved.

23. The power take-off assembly according to claim 17, wherein the energy storage is an elastic energy storage to which elastic energy can be stored and retrieved.

24. The power take-off and generator assembly according to claim 16, wherein the elongated means is any of the following: a chain, a roller screw, a belt, and a wire, and the rotary means is adapted to the transform linear motion in the elongated means into a rotary motion.

25. The power take-off assembly according to claim 18, wherein the hydraulic motor is a fixed displacement hydraulic motor.

26. The power take-off assembly according to claim 18, comprising a flywheel connected to a shaft of the generator.

27. The power take-off assembly according to claim 17, comprising a hydraulic accumulator connectable to a hydraulic circuit,

28. A wave energy system comprising a power take-off assembly according to claim 17 and a plurality of wave energy absorption devices, each wave energy absorbing device comprising:
a buoy adapted to move with movements of water, and
a buoy oscillation device attached to the buoy, the buoy oscillation device comprising an elongated means and a rotary means adapted to interact with the elongated means,
wherein a hydraulic pump with variable displacement is connected to the rotary means and connectable to a hydraulic circuit, wherein, when the buoy moves with movements of water, relative movement is created between the elongated means and the hydraulic pump, whereby the hydraulic pump transforms kinetic energy into hydraulic energy, the plurality of wave energy absorption devices connected to the power take-off assembly by means of a hydraulic circuit.

29. The wave energy system according to claim 28, comprising a pressure relive valve adapted to open on a maximum pressure set for the hydraulic circuit and let hydraulic fluid pass directly from a high pressure hose to a low pressure circuit.

30. The wave energy system according to claim 28, wherein the force applied to the elongated means in each buoy connected to the power take-off and generator assembly, can be controlled independently without significant interference with energy storage or combinations thereof.
